(19) United States
(12) Patent Application Publication
(10) Pub. No.: US 2013/0210395 A1
(43) Pub. Date: Aug. 15, 2013

(54) OPTIMIZING SELECTION OF METHOD OF DETERMINING LOCATION IN A SOCIAL NETWORKING SYSTEM USING MOBILE COMMUNICATIONS

(71) Applicants: Naquib U. Hatami, Fairfax, VA (US); Hamid Daroui, Mission Viejo, CA (US)

(72) Inventors: Naquib U. Hatami, Fairfax, VA (US); Hamid Daroui, Mission Viejo, CA (US)

(21) Appl. No.: 13/586,702

(22) Filed: Aug. 15, 2012

Related U.S. Application Data
(63) Continuation-in-part of application No. 12/437,875, filed on May 8, 2009, now abandoned.

(51) Int. Cl. H04W 4/02

(52) U.S. Cl. CPC H04W 4/02
USPC 455/414.1; 455/456.3

(57) ABSTRACT

A method of selecting an optimal mode of determining location in a social networking system which uses mobile communications devices such as cellular telephones. The system may select GPS, aGPS if the communications device is so enabled, or cellular telephone triangulation, depending upon equipment and operability. A hybrid employing both GPS and also aGPS may be utilized. Once determined, location may be displayed graphically using a map. Those functions of the social networking dependent upon member location may then be implemented. The internet may be employed as a communications link.

### CROSS-REFERENCE TO RELATED APPLICATION

This is a Continuation-In-Part of Ser. No. 12/437,875, filed May 8, 2009.

### FIELD OF THE INVENTION

The present invention pertains to determining location in social networking systems, using mobile communications devices such as cellular telephones.

### BACKGROUND OF THE INVENTION

Social networks which provide member to member communication have become quite popular. In social networks, meetings and interpersonal communications occur, with location of members playing a role in determining whether to meet, what to do, and other aspects of member activities. For example, socially oriented services have been implemented for enabling people to meet others who are interested in social introductions, marriage, friendship, and general social or business contacts. These services may utilize computerized systems of matching up people according to common interests, desires, and the like (hereinafter referred to as characteristics). The basic data providing the basis to judge or identify the characteristics is typically provided by data collected from each participant or subscriber. Suggested pairings are made when certain criteria are met.

However, actually agreeing upon a meeting runs into the usual logistical constraints based on location of each participant and of scheduling. Ability to schedule an intended face-to-face meeting, introduction, or telephone type connection may be delayed by geographic separation of the parties, conflicting schedules, and other factors. The meeting is therefore subject to being objectionably delayed or in more extreme examples, abandoned.

Social networking systems frequently incorporate a location determination feature. Suggested meetings or other pairings may for example be dependent upon determining proximity or location of the parties. Location may be determined for example by using the Global Positioning System of satellites (GPS) or by relying upon cellular telephone triangulation.

Each of these modes of location determination entails certain drawbacks. In the case of GPS, successful operation depends upon a mobile communications device being fitted with GPS capability. Also, successful use of GPS depends upon line-of-sight communication with the satellites. Entering a building, tunnel, or other structure, and in some cases, being covered by a tree canopy or the like may interfere with GPS operation. GPS systems may require more time to deliver results, and may objectionably deplete the battery of a mobile telephone or the like.

Cellular telephone triangulation may fail to give accuracy of GPS systems. In crowded places, it may be desirable to offer greater accuracy than is available from cellular telephone triangulation systems.

Therefore, the most desirable method of locating a participant in a social networking system may change with circumstances. Any one method of determining location may be unsuitable in any particular situation.

### SUMMARY OF THE INVENTION

The present invention addresses the above deficiency in known social networking systems by providing alternative location determination methods, and by establishing a hierarchy of desirablility in such systems. Notably, the present system utilizes at least one of GPS and assisted GPS (hereinafter referred to as aGPS), and cellular telephone triangulation. All three of these modes of determining location may be called into play, including a hybrid of GPS and aGPS. Results may be entered into the system in as close to real time conditions as feasible.

The method of selection of mode of location determination may then be employed to implement any type of social network.

This management of location determination provides the best available location information while conserving battery resources of the mobile communications device, thereby maximizing usefulness and reliability of a social networking system.

### BRIEF DESCRIPTION OF THE DRAWINGS

The drawings represent steps of a method which is the subject of the invention. Each block summarizes the corresponding step rather than setting out that step in full.

FIG. 1 is a block diagram of steps of a method according to at least one aspect of the invention.

FIG. 2 is a block diagram showing an optional step which may be performed as part of the method of FIG. 1.

FIG. 3 is a block diagram showing three steps which may optionally be incorporated into the method of FIG. 1.

FIG. 4 is a block diagram showing an optional step which may be performed as part of the method of FIG. 1.

FIG. 5 is a block diagram showing an optional step which may be performed as part of the method of FIG. 1.

FIG. 6 is a block diagram showing an optional step which may be performed as part of the method of FIG. 1.

FIG. 7 is a block diagram showing an optional step which may be performed as part of the method of FIG. 1.

FIG. 8 is a block diagram showing an optional step which may be performed as part of the method of FIG. 1.

FIG. 9 is a block diagram showing an optional step which may be performed as part of the method of FIG. 1.

FIG. 10 is a block diagram showing an optional step which may be performed as part of the method of FIG. 1.

FIG. 11 is a block diagram showing an optional step which may be performed as part of the method of FIG. 1.

### DETAILED DESCRIPTION

The present invention improves upon social networking systems using mobile communications which rely upon location of individual members. As employed herein, the term “social network” is to be taken in its broadest meaning, and will be understood to encompass systems ranging from two members to large numbers of members, including systems wherein members are not acquainted with one another. Also, social networks will be understood to encompass all possible purposes and applications, not merely those relating to amusement, personal introductions, purely social encounters, and the like. For example, social networks will be understood to encompass commercial purposes such as management of fleets and large numbers of geographically scattered personnel, security systems, asset and object tracking, and others.

In a social network which may employ the novel location determination optimization, at least one member is provided with a mobile communications device, such as a cellular or mobile telephone, personal digital assistant, portable personal computer, or the like. Known communications channels, such as mobile telephone systems, the internet, other systems, and combinations of these may be utilized in interpersonal communications among members. In most cases, there will be a central station having processor capability for performing necessary administrative tasks to implement the purposes of the social network. The social network may be any known social network and may operate for any purpose or application, wherein the social networking system operates at least in part based upon determining geographic location of members of the social networking system.

The invention comprises a method 100 of selecting among a plurality of choices of location determining systems which are operable to determine location of mobile communications devices. In the invention, the method 100 may be utilized to implement operation of the associated social networking system.

The method 100 may comprise a step 102 of providing a mobile communications device having at least two modes of location determination, wherein available modes of location determination include a first mode based on selecting one of Global Positioning System (GPS) capability and assisted Global Positioning System (aGPS) capability, and a second mode based on cellular telephone triangulation capability.

The method may comprise a step 104 of establishing a hierarchy of desirability of the modes of location determination. Establishment of a hierarchy of desirability of the modes may for example place a GPS based mode at the top, or alternatively stated, as the most desirable option. This may be done for example where the party being monitored as to location has a GPS enabled communications device and is in a place wherein he or she is within line of sight relationship to GPS satellites. Where it is desired to conserve battery power in a mobile communications device, aGPS may be established as the most desirable mode of location determination. Also, aGPS may be established as the most desirable mode should real time tracking become desirable. Cellular telephone triangulation may be established should the GPS and aGPS modes not be feasible.

It should be noted that the hierarchy may be changed from one usage of the social networking system to another, and even within one usage should the user's desires, priorities, or circumstances change. The hierarchy may be manually selectable or calculated based on user inputs regarding background requirements and conditions for an individual usage.

The method 100 may comprise a step 106 of determining operability of the most desirable mode of location determination. For example, if a GPS based mode is selected, the line of sight condition may determine operability. In another example, should urgency of tracking assume new importance, the system may automatically switch to an aGPS based mode.

The method 100 may comprise a step 108 of establishing location data of the mobile communications device of the monitored or tracked party from the most desirable mode of location determination if the most desirable mode of location determination is deemed operable as a result of the step 106.

Should the step 106 determine inoperability of the most desirable mode of operation, then the method may comprise a step 110 of determining operability of the next most desirable mode of location determination. If the step 110 is utilized, it may be followed by a step 112 of establishing location data of the mobile communications device from the next most desirable mode of location determination.

Once the system is cleared to determine location and does so, as for example as seen in the steps 108 and 112, then the method may comprise a step 114 of conducting at least one operation of the social networking system based on location of the mobile communication device as determined by that mode of location determination which was utilized.

The step 102 of providing a mobile communications device having at least two modes of location determination may comprise a further step 116 of providing a mobile communications device having at least three modes of location determination, including all of the modes of location determination include Global Positioning System (GPS) capability, assisted Global Positioning System (aGPS) capability, and cellular telephone triangulation capability.

The method 100 may be modified to utilize a hybrid of the modes utilizing GPS and aGPS methods. In the hybrid mode, conducting location polling may use aGPS interspersed with GPS polling conducted at relatively greater time intervals. The GPS system may for example poll the system to acquire location data at time intervals, such as every fifteen minutes, whereas the aGPS system may utilize time intervals such as every five minutes. Where the aGPS system can accommodate more frequent polling requests, and may therefore be more desirable than the GPS mode, the method 100 may comprise a further step 118 of establishing the aGPS based mode as the more desirable of the choice between GPS and aGPS, a step 120 of establishing operability of the aGPS based mode, and if operability is not confirmed, a step 122 of establishing a hybrid mode employing both GPS and aGPS should operability of the aGPS based mode be determined as inoperable. If the purely aGPS based mode be deemed inoperable, the method 100 may comprise a step 124 of proceeding with determining location using the hybrid mode.

Of course, should the GPS and aGPS based modes, including the hybrid mode be determined as inoperable or not feasible, then the method 100 may comprise a step 126 of defaulting to the second mode based on based on cellular telephone triangulation capability, and a subsequent step 128 of proceeding with determining location using the second mode based on cellular telephone triangulation.

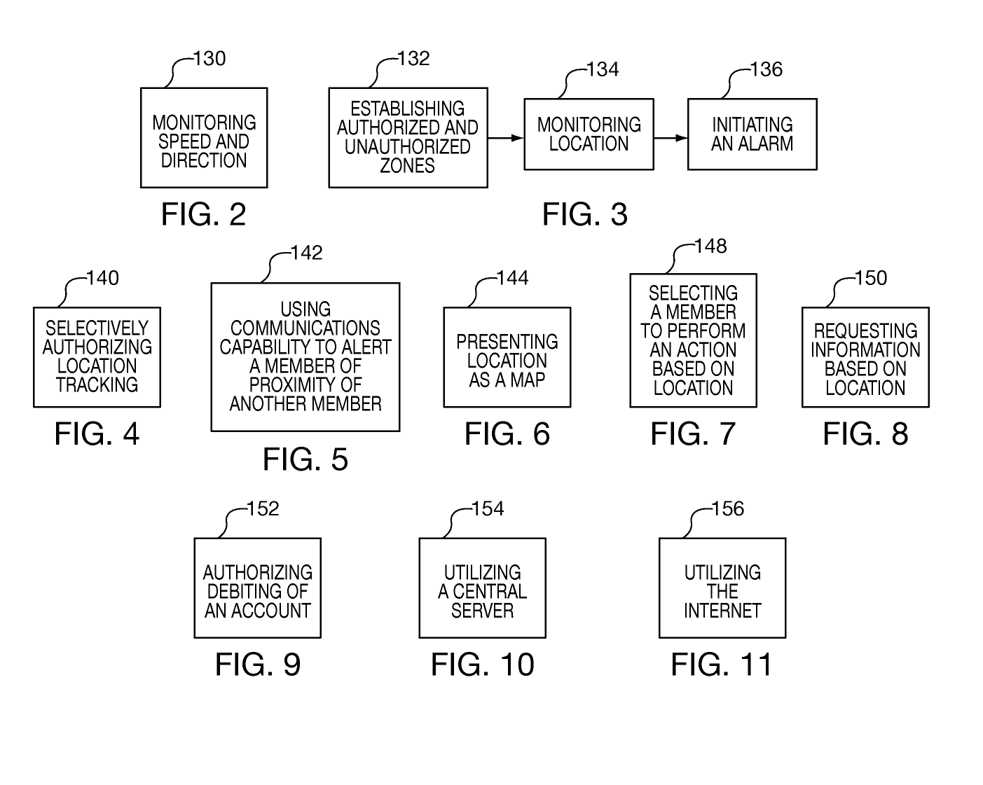

Aspects of the method 100 detailed thus far pertain to how geographic location of a monitored or tracked member of the social network may be determined. Some examples of how location may be utilized with a social network, and variations in how the method 100 may be implemented will now be set forth.

Where location data polling requests are conducted frequently, it would be possible to report to the requester both location data and also the rate at which location is changing. The system may for example identify a number of geographic locations of the tracked or monitored party together with the times at which each location was identified. At least two locations may be used to establish a direction. Alternatively, the system may calculate an average speed over a given time interval and report the locations and the average speed. The system may calculate the direction and report the direction as for example a compass direction, together with the average speed. Regardless of how the system is configured to report location and time data, the method 100 may comprise a step 130 (see FIG. 2) of monitoring speed and direction of a member of the network using sensed location points and time. Monitoring and reporting speed and direction is an option which may or may not be called into play as some operations of a social network are not dependent upon this information. However, this option gives the user additional information for the purpose for example of adjusting a priorly established intention regarding a subsequent course of action to be pursued using the social networking system. As an alternative to reporting location and speed data, the system may upon gathering this data implement automatic adjustments, such as initiating telephone calls, causing messages to appear on a screen of a mobile communications device, or the like, and not actually report the location and speed data.

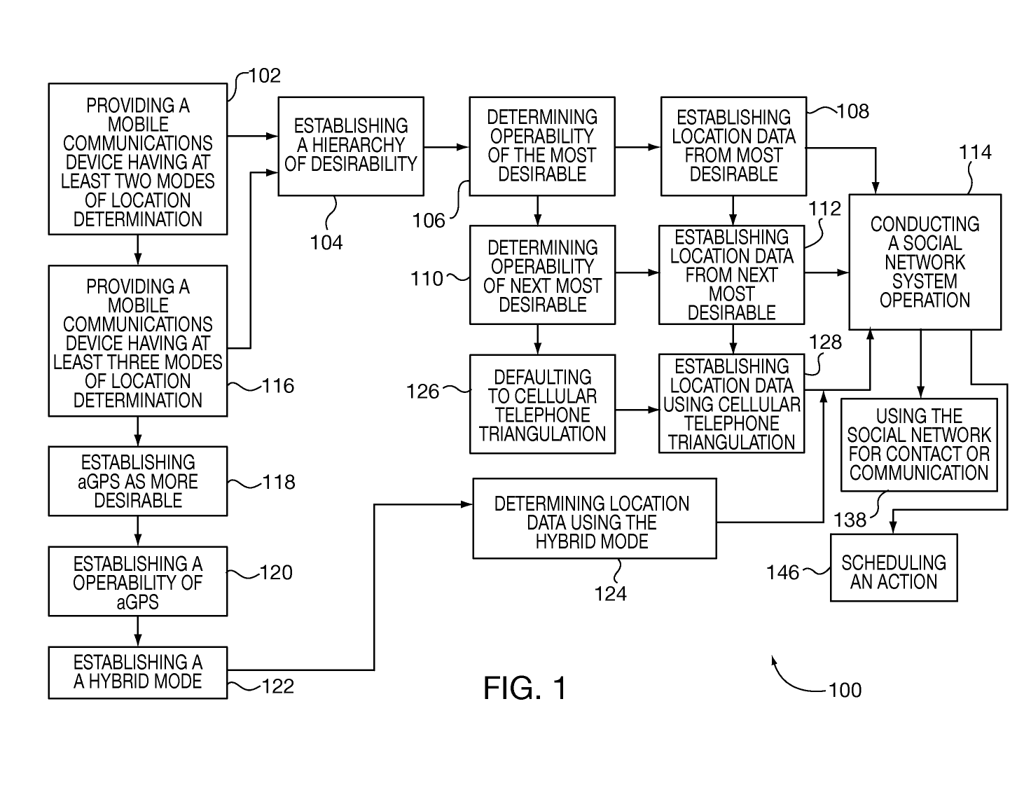

An illustrative example of a social networking system is that which establishes a first geographic zone which a party or member of the system is authorized to occupy, and a second geographic zone which is unauthorized. For example, small children may be confined to the yard surrounding their house or to a schoolyard. In this case, the yard is the authorized zone and travel outside of the yard would place a child in an unauthorized zone. Where the child or other party or member is may be established using the location determination feature of the social networking system, and may for example utilize any of the steps 102 . . . 128 or any combination of these steps. Therefore, in a further option, and referring to FIG. 3, the method 100 may comprise an optional step 132 of establishing authorized zones of occupancy and unauthorized zones of occupancy, an optional step 134 of monitoring a member of the network as to whether the member is in an authorized zone or an unauthorized zone, and a further optional step 136 of initiating an alarm signal when the monitored member enters an unauthorized zone. The step 136 may be regarded as a specific variant of the step 114 (conducting an operation of the social networking system) of the method 100, where the method 100 is directed to location related security. Children, employees, pets, and articles of property such as rental property and property being stored or displayed may all be protected in this manner using the steps 132, 134, and 136 as part of the method 100.

Where the purpose of the social networking system is directed to furthering lines of communication, such as establishing or proposing face-to-face meetings or other forms of personal contact, or to establish communications between or among members of the networking system, such as establishing or proposing telephone calls, instant messaging, texting, emailing, and the like, the step 114 may comprise a further step 138, shown in FIG. 1, of using the social network to establish at least one of interpersonal communication and proposing personal contact based on location of at least two members of the network. Establishing or proposing face-to-face meetings and other forms of personal contact may be based determining whether the paths of travel of the two members are close to interesecting. This may be done by extrapolating the paths based on prior direction and optionally, rate of progress such as velocity for example. Actual intersection may be demanded or alternatively, attaining a predetermined degree of proximity of the paths may be relied on.

It will be appreciated that social networks may include large numbers of members some of which are not of interest to any one member at a particular time. More specifically, that one member may wish to establish contact with a particular member yet to exclude others from such contact. To this end, the one member may authorize one or more members of the social network to track location of himself or herself or perhaps still another member. This may be used for example by people who might wish to meet if they are within close predetermined proximity to one another after a particular activity such as shopping, attending a sports event, attending school, going to church, or any other event. In this example, meeting may not be of great consequence and may be proposed only should the travels of the concerned parties bring them into the predetermined degree of proximity. In this case, the method 100 may comprise an optional step 140 (see FIG. 4) of selectively authorizing at least one member of the social network to track location of at least one other member of the social network.

Where no such exclusivity is necessary, and a member of the social networking system desires to meet any other member if proximity of the two makes meeting feasible, then the method 100 may comprise a step 142 (see FIG. 5) of using communications capability of the social networking system to alert a first member of the social network of proximity of a second member when mutual proximity of the first member and the second member is reduced to a predetermined magnitude.

Location established by the social networking system may be presented to that member or members monitoring location of at least one other member in several ways. Where the mobile communications device includes a screen, the location may be graphically displayed in the form of a map. Symbols or icons representing the tracked member may be displayed on the map. Therefore, the method 100 may comprise an optional step 144 (see FIG. 6) of presenting location of a tracked member of the social network graphically in the form of a map, with the location of the tracked member indicated on the map.

The social network system may be utilized to control an aspect of a member's routine based on determined location. For example, an acquaintance or family member may be monitored for location so that an unrelated activity may be scheduled at a time which avoids conflict. An illustration is scheduling of a shopping task at a time when an acquaintance or family member is known to be sufficiently distant so that an expected meeting with this acquaintance or family member will not conflict with the shopping task. In another example, a planned purchase may be rescheduled should the intended purchaser find herself or himself within convenient proximity of a retail outlet where the purchase may be concluded. The step 114 of conducting an operation of the social networking system may be modified therefore to comprise a step 146 (see FIG. 1) of scheduling an action of at least one member of the social network based on determined location.

The social network utilizing the method 100 may comprise a number of members any one of whom is a candidate to undertake a particular activity. Location may prove an advantageous criterion for selecting among peers. For example, a taxi driver may be routed to a particular customer should that taxi driver be available and the closest of the pool of available taxi drivers to that customer. Repair or service personnel may be similarly assigned to subsequent duties. In this case, providing of a service is exemplary of any predetermined action which may be intiated based on determined location. The method 100 may therefore comprise a step 148 (see FIG. 7) of selecting at least one member of the social network to perform a predetermined action, based on determined location.

The step 114 of conducting an operation may comprise a more specific step 150 (see FIG. 8) of requesting information from the mobile communications device based on determined location. Illustratively, a member of a social network may query the system for potential sales if he or she is close to a business or service such as a restaurant, an automatic teller machine, or the like. Similarly, the member may query the system for traffic information upon finding herself or himself at a particular location. In a further example, the member may query the system for a rating, such as a level of skill or prior customer satisfaction, of a professional in one field or another, should the member be in close proximity to the premises of that professional. It should be borne in mind that the requester of the information may possibly not be the same as the party being monitored for location. For example, parents may seek information based on a child's travels and location.

Another type of action which may be performed under the auspices of a social network system is one which authorizes or implements a transaction such as a payment. Tolls on highways may be paid automatically from a preestablished debit account or the like, using location as one criterion in the decision to accept or implement the transaction. Therefore, the method 100 may comprise a step 152 (see FIG. 9) of authorizing debiting of a preestablished account based on determined location.

The method 100 may be implemented using a central server which may be for example a resource of the social networking service. The server may perform at least one and more likely, a plurality of tasks involved in the activities of the social networking service. These tasks may include participating in location determination, authorizing members to engage in certain sponsored activities, managing communications, storing records, and others. The server may for example be connected to the internet to facilitate communication using the internet. The method 100 may therefore comprise a step 154 (see FIG. 10) of utilizing a central server which is a resource of the social networking system to perform at least one task in at least one of the areas of location determination, of access management within the social networking system, and of communication within the networking system. The method may also comprise a step 156 (see FIG. 11) of utilizing the internet as a communications link for communicating within the networking system.

While the present has been described in connection with what is considered the most practical and preferred embodiments, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. In a social networking system which operates at least in part based upon determining geographic location of members of the social networking system, a method of selecting among a plurality of choices of location determining systems which are operable to determine location of mobile communications devices and to effect a meeting of participants by causing their paths to intersect, comprising the steps of:
providing a mobile communications device having at least two modes of location determination, wherein available modes of location determination include a first mode based on one of Global Positioning System (GPS) capability and assisted Global Positioning System (aGPS) capability, and a second mode based on cellular telephone triangulation capability;
establishing a hierarchy of desirability of the modes of location determination;
determining operability of the most desirable mode of location determination;
establishing location data of the mobile communications device from the most desirable mode of location determination if the most desirable mode of location determination is operable;
determining operability of the next most desirable mode of location determination, if the most desirable mode of location determination is not deemed operable;
establishing location data of the mobile communications device from the next most desirable mode of location determination; and
proposing personal contact between at least two members of the social networking system who might wish to meet if they are within close predetermined proximity to one another, based on location of the mobile communication device as determined using that mode of location determination which was utilized and whether the paths of travel of the two members are close to interesecting.

2. In a social networking system which operates at least in part based upon determining geographic location of members of the social networking system, a method of selecting among a plurality of choices of location determining systems which are operable to determine location of mobile communications devices and to effect a meeting of participants by causing their paths to intersect, comprising the steps of:
providing a mobile communications device having at least two modes of location determination, wherein available modes of location determination include a first mode based on Global Positioning System (GPS) capability, a second mode based on assisted Global Positioning System (aGPS) capability, and a third mode based on cellular telephone triangulation capability;
establishing a hierarchy of desirability of the modes of location determination;
determining operability of the most desirable mode of location determination;
establishing location data of the mobile communications device from the most desirable mode of location determination if the most desirable mode of location determination is operable;
determining operability of the next most desirable mode of location determination, if the most desirable mode of location determination is not deemed operable;
establishing location data of the mobile communications device from the next most desirable mode of location determination; and
proposing personal contact between at least two members of the social networking system who might wish to meet if they are within close predetermined proximity to one another, based on location of the mobile communication device as determined using that mode of location determination which was utilized and whether the paths of travel of the two members are close to interesecting.

3. The method of claim 2, comprising the further steps of:
establishing the aGPS based mode as more desirable than GPS;
establishing operability of the aGPS based mode;
establishing a hybrid mode employing both GPS and aGPS should the aGPS based mode be determined as inoperable if utilized solely in the absence of GPS; and
proceeding with determining location using the hybrid mode should the hybrid mode be determined to be operable.

4. The method of claim 3, comprising the further steps of:
defaulting to the second mode based on cellular telephone triangulation capability should the hybrid mode be determined to be inoperable; and
proceeding with determining location using the second mode based on cellular telephone triangulation.

5. The method of claim 3, wherein the step of establishing a hybrid mode employing both GPS and aGPS comprises the further step of conducting location polling using aGPS interspersed with GPS wherein GPS polls the system at certain time intervals, and aGPS polls the system at other time intervals which increase relative frequency of polling requests.

6. The method of claim 1, further comprising a step of monitoring speed and direction of a member of the network using sensed location points and time.

7. The method of claim 1, further comprising the steps of:
establishing authorized zones of occupancy and unauthorized zones of occupancy,
monitoring a member of the network as to whether the member is in an authorized zone or an unauthorized zone, and
initiating an alarm signal when the monitored member enters an unauthorized zone.

8. The method of claim 1, further comprising the step of using the social network to establish interpersonal communication based on location of at least two members of the network.

9. The method of claim 1, further comprising the step of selectively authorizing at least one member of the social network to track location of at least one other member of the social network.

10. The method of claim 9, further comprising the step of using communications capability of the social networking system to alert a first member of the social network of proximity of a second member when mutual proximity of the first member and the second member is reduced to a predetermined magnitude.

11. The method of claim 1, further comprising the step of using communications capability of the social networking system to alert a first member of the social network of proximity of a second member when mutual proximity of the first member and the second member is reduced to a predetermined magnitude.

12. The method of claim 11, further comprising the step of presenting location of a tracked member of the social network graphically in the form of a map, with the location of the tracked member indicated on the map.

13. The method of claim 1, comprising a further step of utilizing a central server which is a resource of the social networking system to perform at least one task in at least one of the areas of location determination, of access management within the social networking system, and of communication within the networking system.
